(19) United States
(12) Patent Application Publication
(10) Pub. No.: US 2018/0185215 A1
(43) Pub. Date: Jul. 5, 2018

(54) TILT-IN-SPACE WHEELCHAIR WITH DYNAMIC TILT RANGE

(71) Applicant: PDG Product Design Group Inc., Vancouver (CA)

(72) Inventors: Torr Brown, North Vancouver (CA); Bahareh Najafi-Ashtiani, Vancouver (CA); James Formby, Vancouver (CA); Julian Richter, Vancouver (CA); Louis Belanger, Victoria (CA); Patrick Chelf, Edina, MN (US)

(21) Appl. No.: 15/861,656

(22) Filed: Jan. 3, 2018

Related U.S. Application Data
(60) Provisional application No. 62/442,202, filed on Jan. 4, 2017.

(51) Int. Cl. A61G 5/10

(52) U.S. Cl. CPC A61G 5/1075; A61G 5/1064; A61G 5/1089; A61G 5/1067

(57) ABSTRACT

A wheelchair provides a tilt function characterized by tilt-in-space behaviour in the posterior tilt range and wherein in the anterior tilt range, the seat to backrest angle opens as the seat tilts forward.

### PRIORITY CLAIM

The present application is a non-provisional utility application of U.S. Provisional Application Ser. No. 62/442,202, entitled TILT-IN-SPACE WHEELCHAIR WITH DYNAMIC TILT RANGE, filed Jan. 4, 2017, in which the contents are hereby incorporated by reference.

### FIELD OF THE INVENTION

This invention relates to wheelchairs. In particular, this invention relates to a tilt-in-space wheelchair having the ability to substantially tilt-in-space in the posterior range and to change the angle between the seat and the backrest while tilting in the anterior range.

### BACKGROUND OF THE INVENTION

It is known in the prior art to have a tilt-in-space wheelchair in which the entire upper frame tilts as a unit, thereby maintaining the angle between the backrest and the seat pan through the range of tilt. It is in fact desirable to have a tilt-in-space feature for code and funding reasons and users appreciate the continued comfort offered by the tilt-in-space feature. Some tilt-in-space wheelchairs provide a mechanism to keep the center of gravity of the occupant centered on the wheelchair despite the different tilt angles.

In some cases, tilt-in-space operation can impede the user from exiting the seat in the anterior range of tilt or can reduce the stability of the user when tilting forward. Some non-tilt-in-space chairs allow the angle between the seat and the backrest to open up to avoid pinching the user between them when trying to straighten out the posture in order to exit the chair.

It is known to provide a stand-up wheelchair in which the chair can be reconfigured from a normal seating position to a position in which the seat elevates while the angle between the seat and the backrest opens up. This allows the seat and the backrest to end up in a co-linear or at least quasi-parallel arrangement to accommodate a standing position.

U.S. Pat. No. 6,588,792 discloses a power assisted arrangement for tilting the seat of a chair, and for independently rotating the backrest in relation to the seat. A controller controls both operations so as to achieve combinations of seat tilt and backrest angle and seeks to adjust the relative seat-to-backrest angle when unreclining the backrest of the chair. There is no discussion of a means of enabling substantially tilt-in-space behaviour in the posterior tilt range and a varying seat to backrest angle in the anterior tilt range. While some powered chairs offer the ability to adjust recline and tilt separately, the added weight required for batteries and power components is often undesirable and significantly increases the cost and maintenance required for some chairs.

WO2013/066198 applies the principle of a scissor lift to wheelchairs, in which it is used to elevate the seat without tilting it. A different actuation and cam system is used to achieve a tilt-in-place function for the seat/backrest assembly.

US Patent Pub 2008/0106060 discloses a two stage tilt arrangement that relies on an arrangement of two cylinders, but that are actuated separately to achieve each of the two stages of tilt. The two stage tilting does not affect the angle between the seat and the backrest. That angle is affected by a separate actuation gas spring.

WO2015/131296 discloses a stand-up wheelchair that involves a parallelogram arrangement of “rods” that cooperate to open the angle to the backrest (as required) when moving to the stand-up configuration. The publication does not provide detail of the movement of the joints but does point out that the position of a joint can be shifted relative to the other joints, making the inclination of the backrest variable to the seat surface. The shifting of the position of the joints appears to be accomplished by locking the joints in position along a slot. It does not offer a tilt-in-space feature.

DE102008024745 discloses the use of a parallelogram with selected hinge points to cause relative movement of the backrest and seat while the seat is moved from a seated position to a stand-up configuration. The described chair does not apparently offer a tilt-in-space feature.

It is an object of the present invention to have a differential behaviour as between the anterior and posterior zones of tilt of a wheelchair that does not have an electrically powered recline function.

More particularly, it is an object of this invention to provide a wheelchair having a tilt-in-space mode of operation but that better accommodates a user in the anterior range of tilt by avoiding pinching the user who might try to stand from the seat in the anterior range of tilt and enhance the stability of the user if not intending to exit the chair.

These and other objects of the invention will be better understood by reference to the detailed description of the preferred embodiment which follows. Note that the objects referred to above are statements of what motivated the invention rather than promises. Not all of the objects are necessarily met by all embodiments of the invention described below or by the invention defined by each of the claims.

### SUMMARY OF THE INVENTION

The invention provides a tilt-in-space mode of operation when tilting a tiltable wheelchair seat posteriorly. When it is tilted anteriorly, the angle between the backrest and the seat opens to better accommodate the user's stability. The feature can be particularly useful when tilting toward a stand-up configuration but is useful in retaining the user in the seat when tilting forward to any extent.

The invention allows the seat to be tilted backwards (posterior) without substantially changing the angle between the seat pan and the back rest so as to provide a tilt-in-space feature in the posterior range of tilt. When the chair tilts forward (anteriorly) the seat back pivots rearwardly somewhat in relation to the seat pan. This makes it easier to stand up out of the chair, by clearing the area around the user's shoulders, and without having the user's posterior catch in the titled back rest. It also makes the user who does not intend to exit the chair more stable by moving the back rest and consequently the user's center of gravity slightly backwards.

The feature is achieved in two alternative ways.

According to the first approach, the upper frame is connected to a tilt axis allowing the upper frame to tilt in relation the lower frame. Preferably the tilt axis is a hinged connection between the upper frame and a sub-frame that is rigidly connected to the lower frame. A guide plate is pivotally attached to the upper frame and, through the intermediary of a recline hydraulic cylinder assembly, to the backrest. The guide plate is also engaged onto the sub-frame by a slot in the guide plate that engages with a slide arm or pin on the sub-frame. The connection between the guide plate and the sub-frame that the pin provides is constrained by the shape and location of the slot and the path of the pin along the slot.

The rod of the recline hydraulic cylinder assembly is locked during tilt so that its longitudinal extent does not change. As a result, any longitudinal force on the rod will cause the backrest to react by reclining or redressing along its pivoting connection to the upper frame. The shape and curvature of the slot therefore determines the behaviour of the backrest as the sub-frame reacts to the tilting of the upper frame. The nature of that reaction is governed by the shape of the slot.

As the seat is tilted through the posterior range, the radius of curvature of the slot on the guide plate is selected so that it matches the movement of the sub-frame pin through that range of tilt. The slot therefore accommodates the movement of the pin through the posterior range so that there is no force inducing movement of the guide plate relative to the upper frame and therefore no net force on the recline rod that is connected to the guide plate. It follows that there is no inducement of any recline (or redress) of the backrest.

When the tilt angle is in the anterior range, the slot's curvature and direction is such that the pin now urges the guide plate to pivot against the upper frame and to pull against the recline rod of the hydraulic cylinder assembly. The backrest is thereby urged to open its angle to the seat to accommodate the relative movement of the guide plate in relation to the upper frame.

As a result of the invention, a posterior tilt of the upper frame does not induce any significant change in recline position of the backrest, while an anterior tilt reclines the backrest to open up the seating of the user and allow the user to maintain a center of gravity despite the anterior tilt of the chair.

The second approach does not rely on a slot in a guide plate. As in the first approach, a recline hydraulic cylinder assembly that normally actuates recline of the backrest is attached to the sub-frame which is rigidly connected to the lower frame. If it were attached to the upper frame, the whole upper frame would tilt with the seat and therefore the back rest position would not change with respect to the seat during tilting. By connecting the recline rod to the sub-frame, as the upper frame is tilted about the lower frame (by means of a separate tilt hydraulic cylinder assembly between the upper and sub-frame), the backrest will recline more or less in relation to the seat depending on the configuration of the recline hydraulic cylinder assembly and the positions of the mounts of the rod and the cylinder and the pivot axes for the tilt and the recline functions.

The recline rod is locked during tilt so that longitudinal extent of the hydraulic cylinder assembly does not change. The configuration of the longitudinal axis of the hydraulic cylinder assembly and of the rod and cylinder mounts and the tilt and recline pivot axes is such that as the upper frame tilts through the anterior tilt range, the change in angle of the recline hydraulic cylinder assembly draws back on the backrest pivot axis causing the backrest to recline with greater effect than in the posterior tilt range. The result is a differential extent of backrest recline as a function of tilt in the posterior and anterior tilt ranges due to a parallelogram arrangement of the mounts and pivot axes.

In a first aspect, the invention is a wheelchair having a manually-actuated tilt function comprising a guide plate having a slot that tracks the movement of an upper frame during posterior tilt of the upper frame, and wherein during anterior tilt of the upper frame, a force is applied against the guide plate to cause a cylinder assembly that is attached to the guide plate to actuate recline of a backrest.

In a more particular aspect, the cylinder assembly is attached to selectively recline a backrest, the cylinder assembly being lockable during tilting of the upper frame. A rod of the cylinder assembly is attached to the plate which is in turn pivotally attached to the upper frame. A guide pin depends from the upper frame and defines a path for the pin as the upper frame is tilted. The pin extends into and is retained in the slot. The slot is configured by its shape and location on the guide plate not to exert substantial resistance to the movement of the pin along the path as the upper frame is tilted in a posterior range of tilt. The slot is further configured to cause the pin to pull the plate forward as the upper frame is tilted in the anterior direction while the cylinder assembly is locked so that the plate exerts a forward force on the locked cylinder assembly. As a result, posterior tilting of the upper frame does not cause the backrest to substantially recline but anterior tilting of the upper frame causes the backrest to recline.

In another aspect, the invention is a wheelchair having a manually-actuated tilt function comprising a cylinder assembly attached to selectively recline a backrest, the cylinder assembly being lockable during tilting of an upper frame of the wheelchair; a member pivotally attached to the upper frame at a tilt pivot axis, and the cylinder assembly having a rod pivotally attached to the member at a point that is spaced from the tilt pivot axis. A longitudinal axis of the hydraulic cylinder assembly and the spacing of the point from the tilt pivot axis is selected so that the backrest does not substantially recline during posterior tilting of the upper frame but the backrest reclines during anterior tilting.

In a more particular aspect, the point of attachment of the cylinder of the cylinder assembly to the backrest assembly defines a path of travel during posterior tilting of the upper frame that is approximately parallel to a tilt arc of the upper frame during posterior tilting. The spacing is effective to cause the path of travel to deviate from the tilt arc to a greater extent than during posterior tilting so as to exert a recline force on the cylinder assembly during anterior tilting.

Preferably, the longitudinal axis of the cylinder assembly aligns with the pivot axis at a tilt angle that is located between 10° and 20° of posterior tilt of the upper frame.

The foregoing may cover only some of the aspects of the invention. Other aspects of the invention may be appreciated by reference to the following description of at least one preferred mode for carrying out the invention in terms of one or more examples. The following mode(s) for carrying out the invention is not a definition of the invention itself, but is only an example that embodies the inventive features of the invention.

### BRIEF DESCRIPTION OF THE DRAWINGS

At least one mode for carrying out the invention in terms of one or more examples will be described by reference to the drawings thereof in which:

FIG. 1 is a front and bottom isometric view of the structural components of a wheelchair according to the preferred embodiment of a first approach of the invention;

FIG. 2 is a front view of the preferred embodiment of a first approach of the invention;

FIG. 3 is a side sectional view taken along line 3-3 of FIG. 2, with the upper frame being in a neutral seated position;

FIG. 4 is the same view as FIG. 3 but with the chair in posterior tilt;

FIG. 5 is the same view as FIG. 3 but with the chair in anterior tilt;

FIG. 6 is a partially exploded side elevation of the chair of FIG. 3;

FIG. 6A is an enlarged side elevation of the guide plate;

FIG. 7 is a partially exploded isometric view of the chair of FIG. 3;

FIG. 8 is a bottom view of the chair of FIG. 2;

FIG. 9 is a front view of the structural components of a wheelchair according to the preferred embodiment of a second approach of the invention, with the right rear wheel removed;

FIG. 10 is a side sectional view taken along line 10-10 of FIG. 9;

FIG. 11 is the same view as FIG. 10 but with the chair in posterior tilt;

FIG. 12 is the same view as FIG. 10 but with the chair in anterior tilt;

FIG. 13 is an isolated view of the upper frame, backrest assembly, sub-frame and recline cylinder assembly of FIG. 10, with the chair in a neutral tilt position;

FIG. 14 is an isolated view of the upper frame, backrest assembly, sub-frame and recline cylinder assembly of FIG. 10 with the chair in posterior tilt;

FIG. 14A is an isolated view of the upper frame, backrest assembly, sub-frame and recline cylinder assembly of FIG. 10 with the chair in posterior tilt and showing a path of travel of a backrest connection point and an arc of travel of the upper frame during tilting; and,

FIG. 15 an isolated view of the upper frame, backrest assembly, sub-frame and recline cylinder assembly of FIG. 10 with the chair in anterior tilt.

### DETAILED DESCRIPTION OF AT LEAST ONE MODE FOR CARRYING OUT THE INVENTION IN TERMS OF EXAMPLE(S)

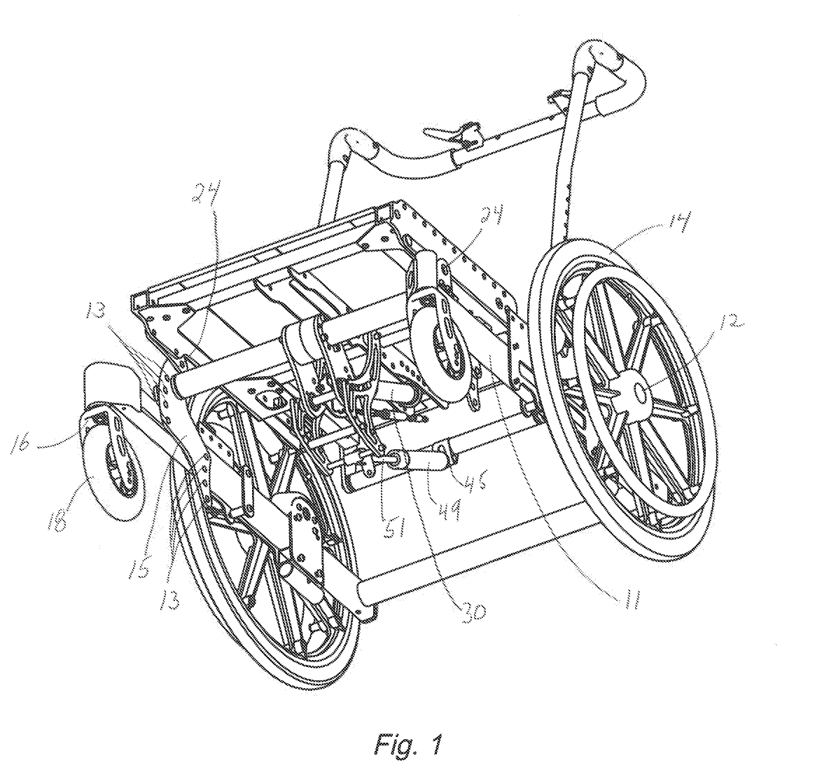

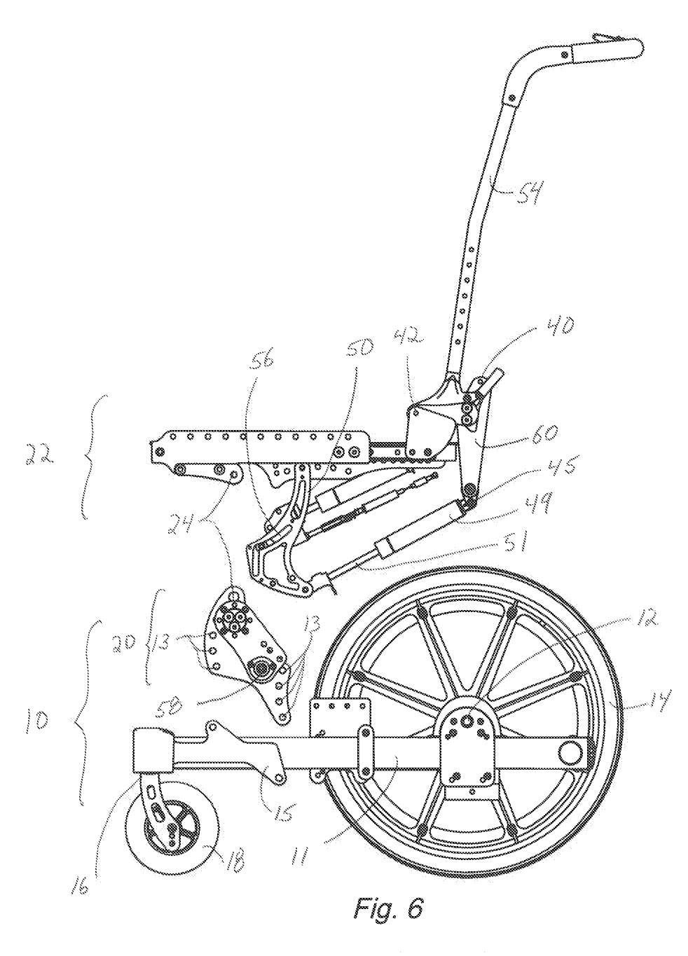

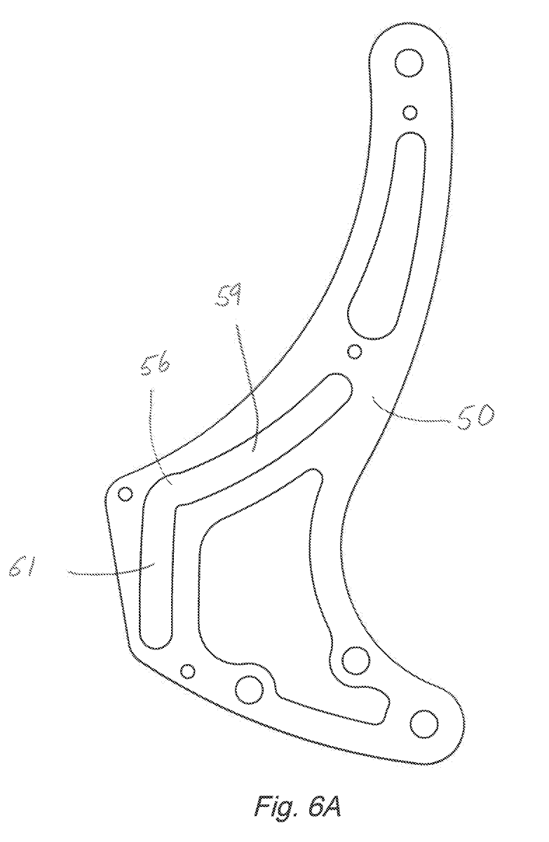

Referring to FIGS. 1 and 6, the wheelchair of the preferred embodiment generally comprises a lower frame assembly 10 that provides mounting locations 12 for the large rear wheels 14 and mounting locations 16 for the small casters 18 which support the wheelchair. A sub-frame assembly 20 is fixedly bolted to the lower frame member 11 by means of two of several attachment positions 13, the plurality of which facilitates height adjustability of the sub-frame relative to the ground. The sub-frame 20 can be considered a sub-component of the lower frame assembly 10. It is attached by mounting plates 15 to the frame member 11.

An upper frame 22 bolts to the sub-frame through a rotatable bolted connection 24, enabling the tilting of the upper frame relative to the sub-frame. The bolted connection 24 is preferably positioned in a location that is sufficiently forward on the chair that when tilting, the vertical movement (rise or drop) of the front of the upper frame is minimized.

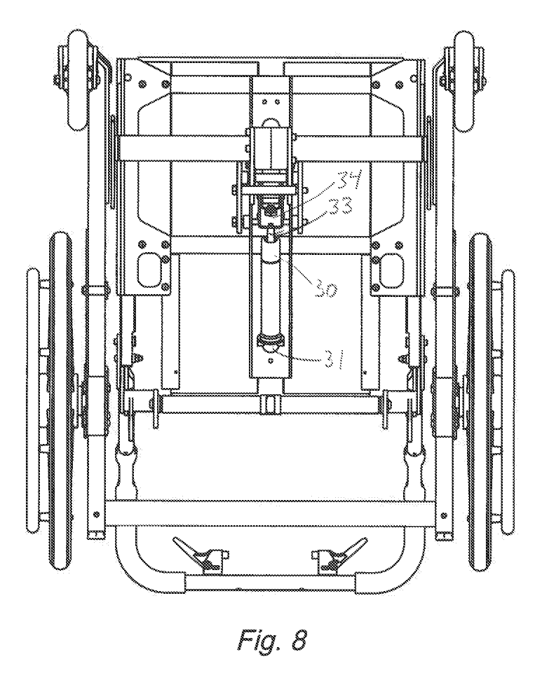

A tilt hydraulic cylinder assembly 30 bolts rotatably to the upper frame at its rearward end 31 (best seen in FIG. 8) and to the sub-frame at its forward end 34. Extension and retraction of the tilt rod 33 actuates rotation of the upper frame relative to the sub-frame about the pivot point 24 to tilt the upper frame. In the preferred embodiment, the tilt cylinder assembly 30 is mounted to the sub-frame 20 such that the seat is in a neutral position)(tilt=0° when the tilt rod 33 is approximately halfway extended. The tilt cylinder assembly 30 further provides an elastic locking function through its travel allowing the upper frame 22 to be parked or locked in a given position relative to the sub-frame 20. According to the preferred embodiment, the upper frame can be positioned from 20° to the posterior to 30° to the anterior direction relative to the sub-frame.

The backrest assembly 40 bolts rotatably to the upper frame near the upper frame's rear end at 42 enabling backrest rotation relative to the upper frame 22. The connection 42 is positioned in a location to minimize shear of the seat and back surfaces. Shear refers to the difference developed between the combined lengths of the seat and back surfaces of the wheelchair and the combined length of the occupant's upper leg and torso, created during the recline motion. If the backrest pivot 42 is located at or very near the occupant's hip joint there will be no shear (or no differential length developed). As the backrest pivot moves away from the hip joint the shear will increase, which is not desirable as the occupant will lose proper alignment with the backrest surface and headrest if there is a headrest. A backrest recline hydraulic cylinder 49 is attached to the backrest assembly 40 at 45 with its rod 51 being attached according to whether the first or the second approach of the invention is being implemented.

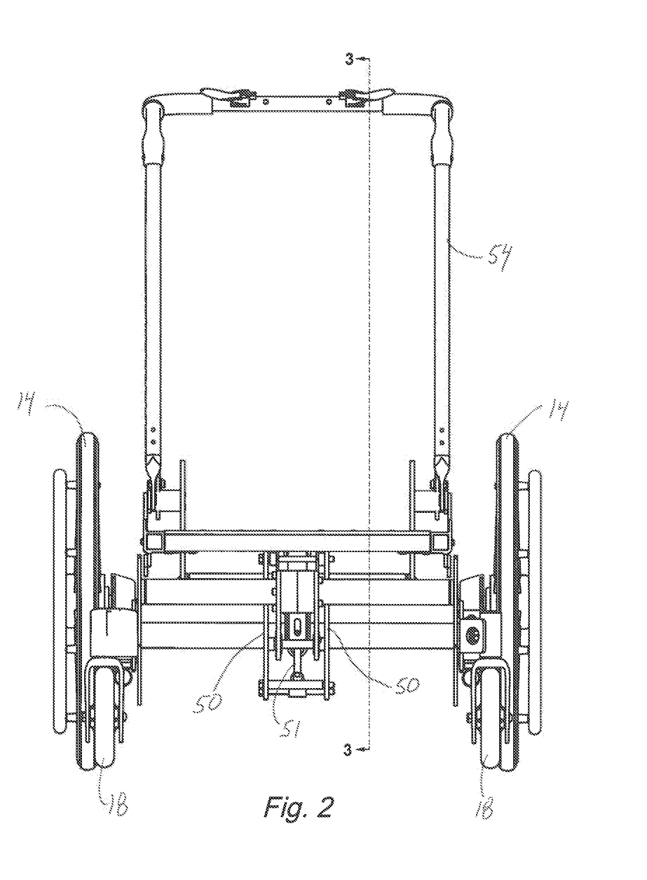

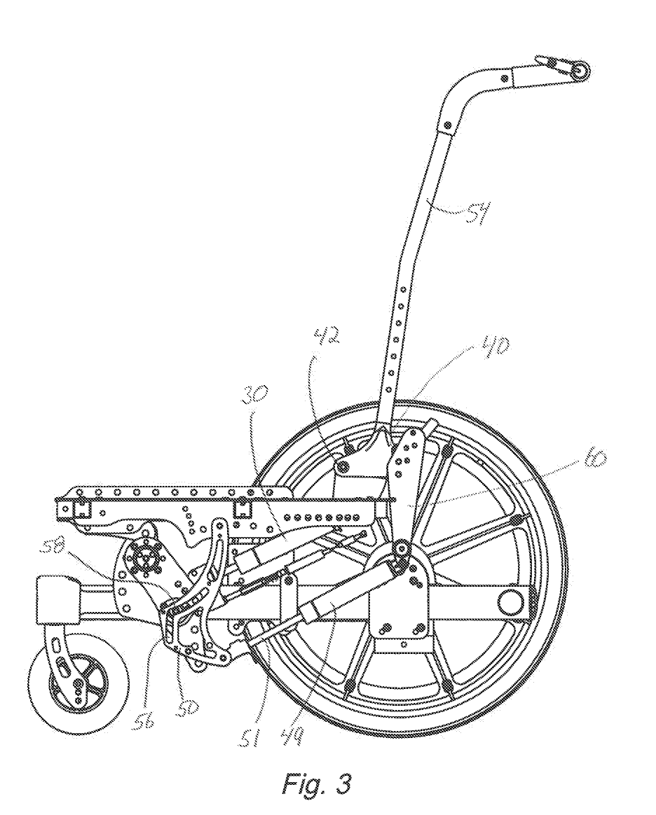

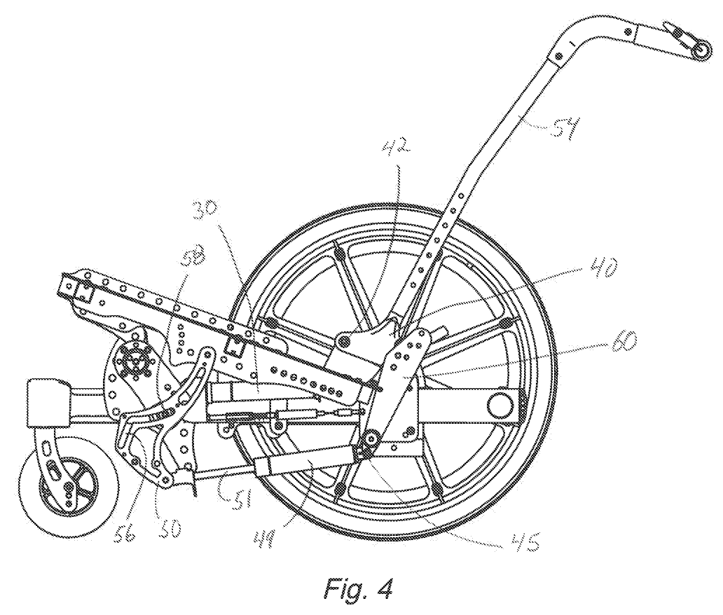

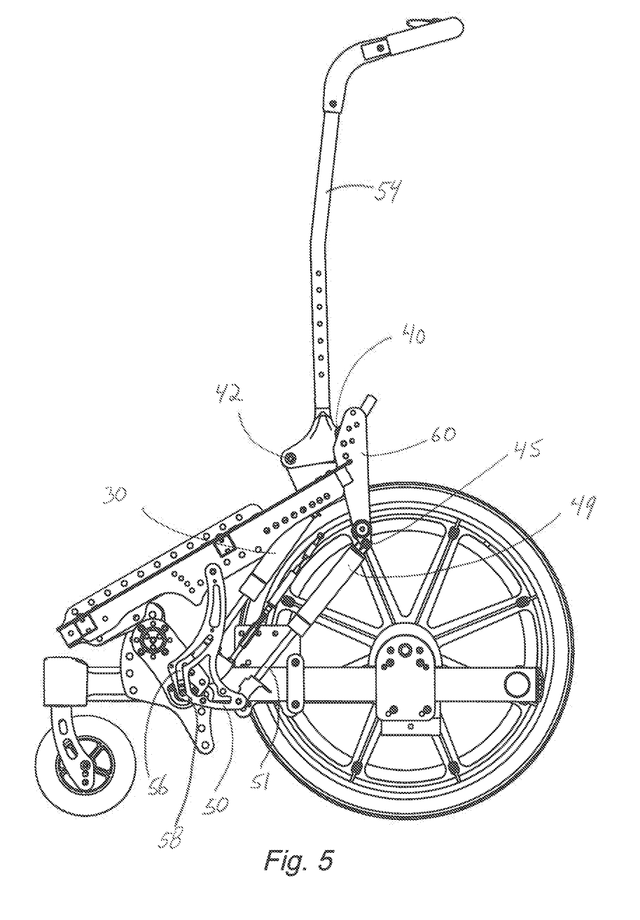

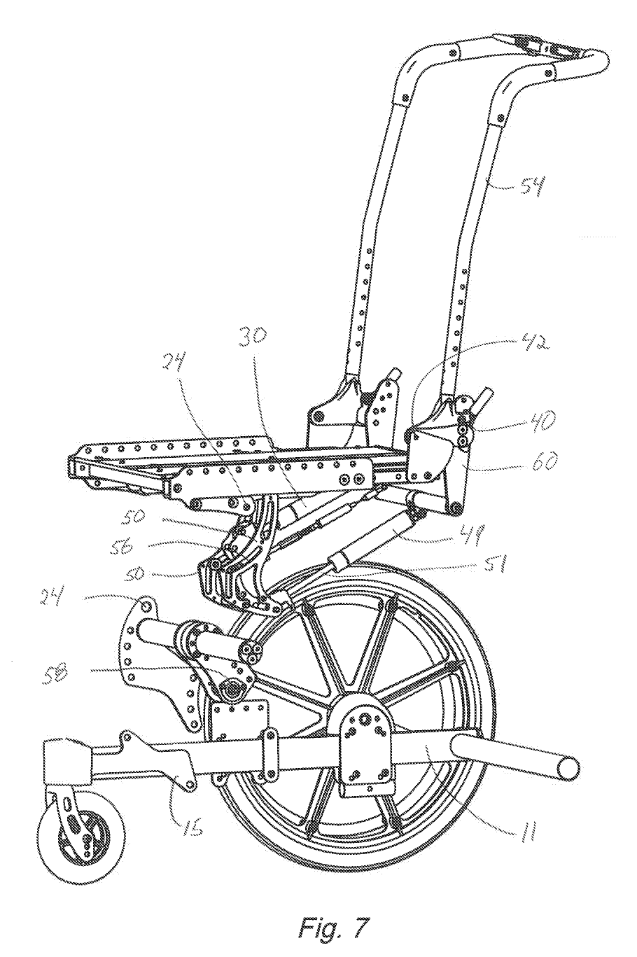

According to the preferred embodiment of the first approach to the invention illustrated in FIGS. 2-8, a guide rail or plate 50 is rotatably attached to the upper frame 22 (preferably one guide plate on each of the port and starboard sides of the wheelchair) and is attached by means of a backrest recline cylinder assembly (cylinder 49 and rod 51) to the backrest assembly 40.

The connection of the guide plate 50 to the upper frame 22 causes the guide plate to move with the upper frame 22 during tilting of the upper frame 22. The guide plate 50 includes a slot 56 for receiving a slide arm or pin 58 that is mounted onto the sub-frame 20. As discussed in the Summary of the Invention, the shape, location and curvature of the slot 56 determines the behaviour of the backrest 54 as the sub-frame 20 reacts to the tilting of the upper frame 22. The backrest is connected to the guide plate 50 by means of the recline cylinder assembly 49, 51, the latter being locked during tilting of the upper frame. As the upper frame 22 is tilted through the posterior range, the movement of the pin 58 that is mounted on the sub-frame 20 matches the path and radius of curvature of the portion 59 (the posterior range) of slot 56. While in posterior tilt, portion 59 of the slot 56 effectively matches the normal movement of the pin 58. The result is no relative movement between the guide plate 50 and the upper frame 22. The slot 56 therefore accommodates the movement of the pin 58 through the posterior range so that there is no net force on the guide plate 50 and therefore no force on the locked recline rod 51 or on the backrest mounting plate 60.

When the tilt angle reaches the anterior range, the slot 56 changes direction (61) so that tilting of the chair causes the pin 58 to now urge the guide plate 50 to pull against the locked recline rod 51. The backrest 54 is thereby urged to open its angle to the seat. More specifically, the guide pin 58 follows the slot 56 in the guide plate 50 in portion 61 of the slot in such a way as to pull the recline rod 51 and therefore the backrest pivot member 60. That in turn causes the backrest 54 to recline in relation to the upper frame 22. The backrest thereby reclines with an anterior tilt. Selecting different shapes and curvatures of the slot 56 can result in different recline behaviour of the backrest.

The recline cylinder assembly 49, 51 further provides an elastic locking function through its travel allowing the backrest 54 to be locked in a position relative to the upper frame 22 for a given upper frame position. The backrest can be positioned from 90° to 130° posterior recline depending on the upper frame position, 90° being a standard perpendicular backrest position.

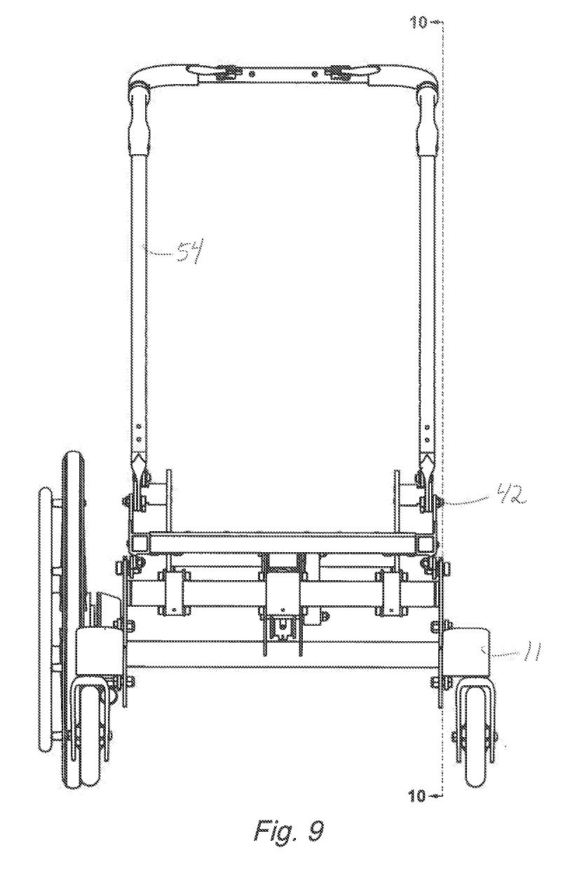

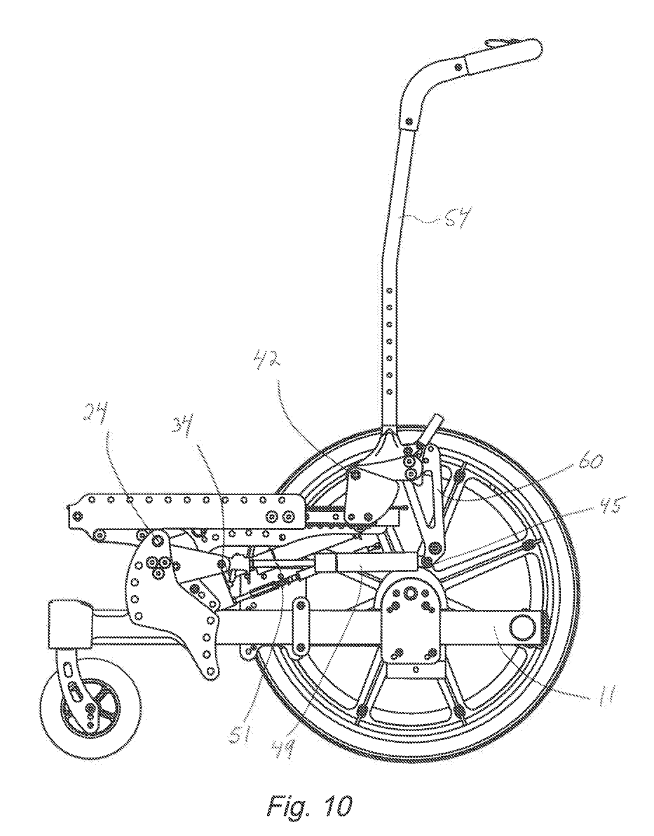

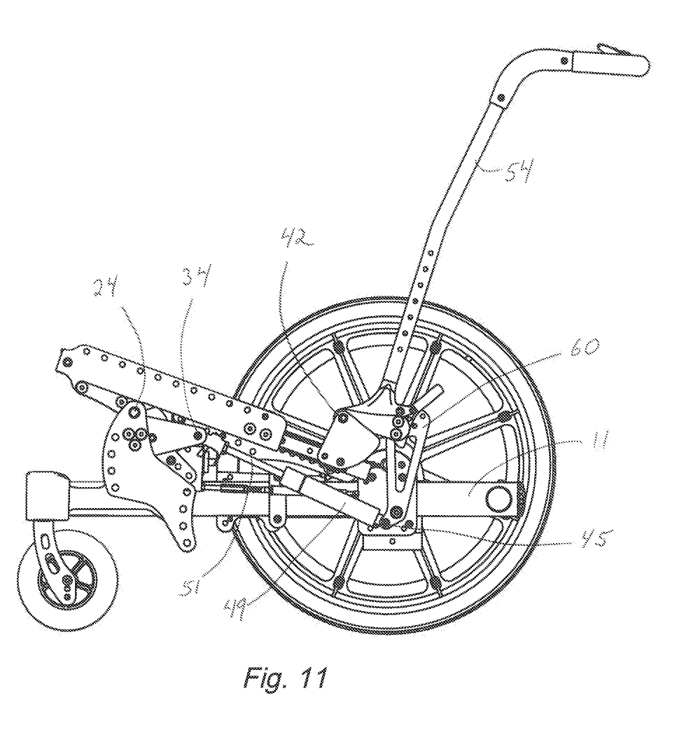

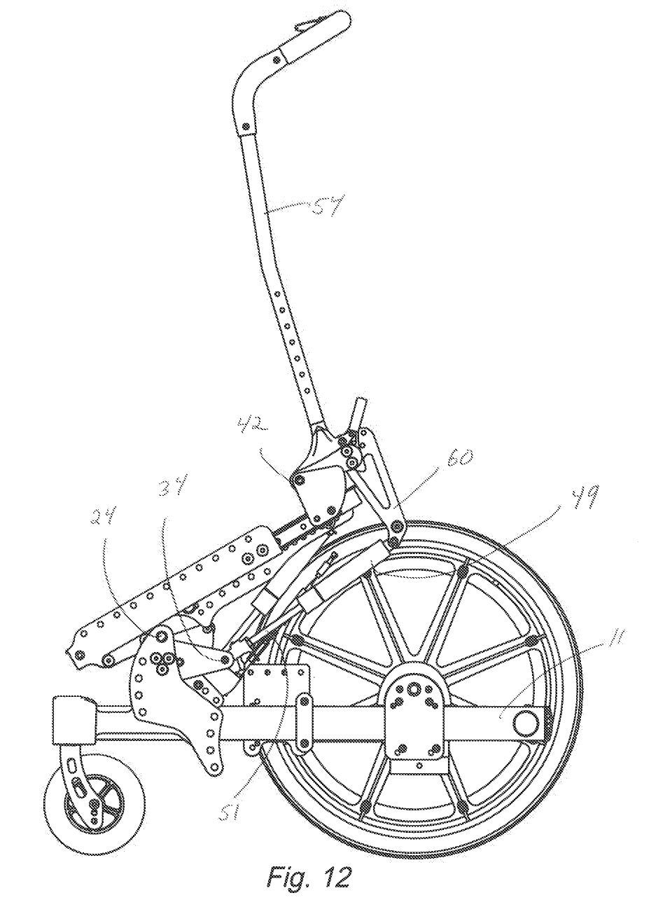

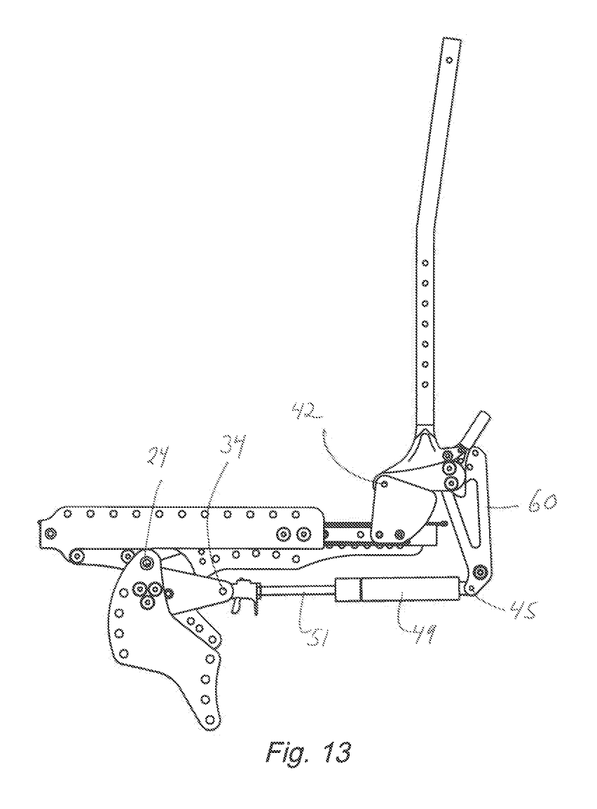

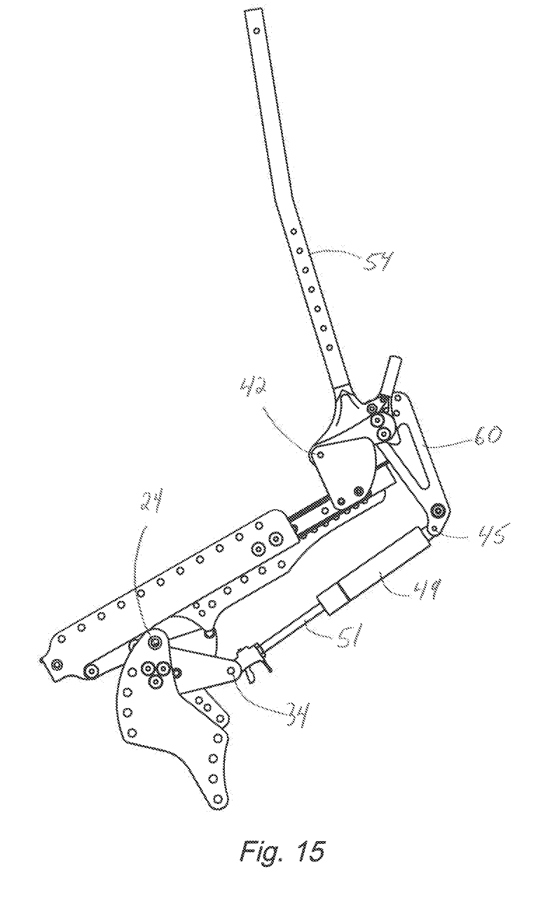

According to the preferred embodiment of the second approach, illustrated in FIGS. 9-15, a backrest recline hydraulic cylinder assembly 49, 51 bolts rotatably to the sub-frame 20 at its forward end 34 and to the mount 60 of the backrest at its rearward end 45. Extension and retraction of the recline rod 51 allows rotation of the backrest relative to the upper frame 22 about pivot axis 42. As will be discussed below, it is primarily the alignment of the longitudinal axis of the recline cylinder assembly 49, 51 with the upper frame tilt axis 24 and the spaced location of the sub-frame recline rod mount 34 in relation to the tilt pivot axis 24 that develop the desired differential backrest angles for the posterior and anterior tilt ranges of the upper frame 22. A parallelogram arrangement of the points 24, 34, 45 and 42 govern the relative movement of the points. According to the preferred embodiment illustrated in the drawings, the backrest angle to the seat/upper frame remains substantially constant (˜2° of recline over 20° of tilt) in the posterior tilt range and the angle opens in the anterior tilt range (˜12° of recline over 30° of tilt).

The recline rod mount 34 on the sub-frame 20 is positioned in a location such that for the posterior tilt range it emulates the recline rod 51 having an upper frame mount (in which case there would be no force on the rod during tilting of the upper frame) while for the anterior tilt range it acts according to the relative positions of the upper frame (to which the backrest is mounted) and the sub-frame 20 on which the rod mount is actually located. When the longitudinal axis of the recline cylinder 49, 51 is broadly in alignment with the upper frame tilt pivot axis 24, the assembly 49, 51 effectively behaves as if it were mounted at the upper frame pivot 24. If the assembly 49, 51 were actually mounted at the upper frame pivot location 24 it would provide no relative movement between the backrest 54 and the upper frame 22 (which is the desired behavior for the posterior tilt range only).

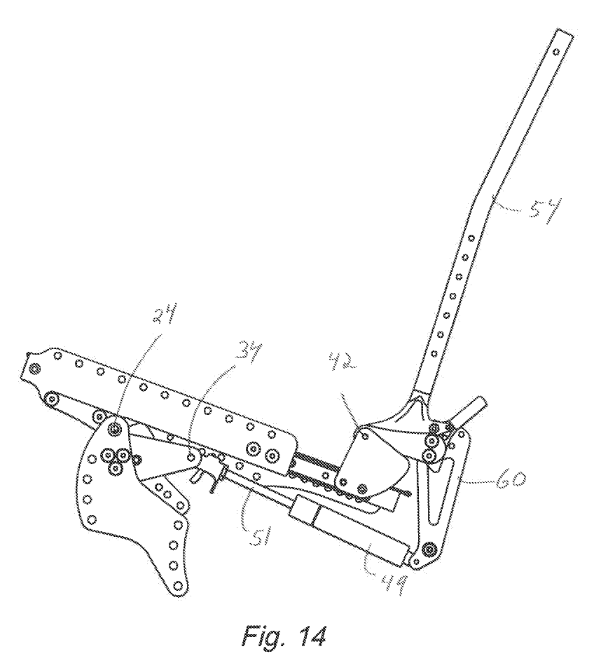

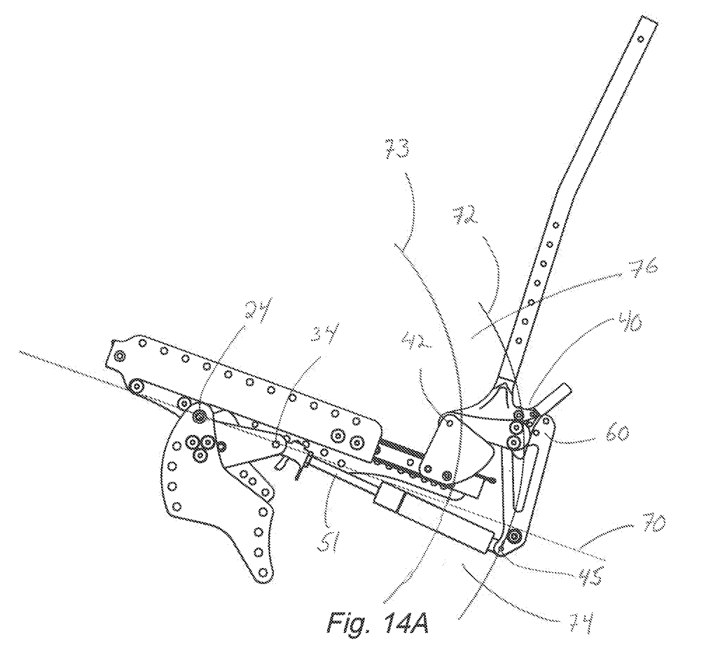

In order to maintain such alignment for the posterior range of tilt, consider a nominal line 70 (see FIG. 14A) connecting the tilt pivot axis 24 and the rod mount 34 and consider further an arc 72 through which the rear of the backrest assembly transits in posterior tilt. Where the rod 51 and cylinder 49 completely align with the tilt axis 24, there will be no force applied to the recline mount 60 during tilt in that portion of the arc 72. In the areas immediately adjacent to that zero point, the force on the recline mount 60 will be negligible, and hence effectively zero as well. The selection of the precise location along the arc 72 at which the rod and cylinder are designed to align perfectly with the tilt axis 24 depends on a trade-off between the area of posterior tilt in which zero backrest recline is desired and the degree to which such position accentuates or not the backrest recline in the anterior tilt zone. The inventors have found that the desired behaviour is achieved when the cylinder assembly 49, 51 is mounted such that the assembly aligns with the tilt pivot axis 24 of the upper frame at a posterior tilt angle of between 10° and 20°. The preferred angle of alignment is about 16.5°.

The effect of the invention may also be appreciated by considering the path of travel 72 of the connection point 45 between the cylinder 49 and the backrest assembly 40 and the tilt arc 73 of the upper frame during posterior tilting. The path of travel 72 is approximately parallel to the tilt arc 73 during posterior tilting of the upper frame as observed in area 74. However due to the spacing between tilt axis 24 and the rod to sub-frame mount 34, the path of travel 72 during anterior tilting deviates from being parallel to the arc 73 to a greater extent than during posterior tilting as at area 76. That deviation exerts a recline force on the cylinder assembly and therefore causes the backrest to recline (since the cylinder assembly is otherwise locked during tilting).

Optionally the recline backrest assembly 40 can further provide an elastic locking function through its travel allowing the backrest to be parked in a position relative to the upper frame for a given upper frame position. The backrest can be positioned from 90° to 130° posterior recline relative to the upper frame, 90° being a standard perpendicular backrest position.

The sub-frame 20 is rigidly fixed in relation to the lower frame 10. The backrest recline rod 51 is rotatably attached to the sub-frame 20 at a point 34 located inboard of the lower/upper frame tilt pivot axis 24. The location of the mount 45 of the cylinder 49 to the backrest assembly is selected such that the recline assembly 49, 51 is generally or nearly aligned with the tilt pivot axis 24 through the posterior tilt range. As a result, upon the upper frame tilting about the tilt pivot axis 24 in the posterior tilt range, there is relatively little change in that alignment angle and therefore little change in distance between the rearward end of the recline assembly 49, 51 and the tilt pivot axis 24 (roughly equivalent to the seat depth and hence no inducement for the backrest to recline). However the rod to sub-frame mount 34 is spaced a sufficient distance from the tilt pivot axis 24 to induce the following behaviour in the anterior range of tilt. The sub-frame 20 is fixed in relation to the lower frame 10 so it does not move as the upper frame 22 tilts. It follows that the location of the recline rod mount 34 to the sub-frame also does not change. It is effectively fixed in space in relation to the lower frame 10. With a sufficient spacing between the tilt pivot axis 24 and the rod to sub-frame mount 34, as the rear of the upper frame 22 crosses over to the anterior range of tilt, the angle of the recline assembly 49, 51 must then move out of alignment with the tilt pivot axis 24 thereby seeking to decrease the distance between the rearward end of the assembly 49, 51 and the tilt pivot axis 24. The distance is maintained by the rod (which is typically locked during the tilt operation) drawing back on the backrest pivot point 45, causing the backrest to recline in the anterior range of tilt.

The second approach thereby provides a differential backrest recline behaviour according to whether the upper frame is tilting in the posterior range or in the anterior range.

In the foregoing description, exemplary modes for carrying out the invention in terms of examples have been described. However, the scope of the claims should not be limited by those examples, but should be given the broadest interpretation consistent with the description as a whole. The specification and drawings are, accordingly, to be regarded in an illustrative rather than a restrictive sense.

The embodiments of the invention in which an exclusive property or privilege is claimed are defined as follows:

1. A wheelchair having a tilt function comprising a guide plate having a slot that tracks the movement of an upper frame during posterior tilt of said upper frame, and wherein during anterior tilt of said upper frame, a force is applied against said guide plate to cause a cylinder assembly that is attached to said guide plate to actuate recline of a backrest.

2. The wheelchair of claim 1 wherein said cylinder assembly is attached to selectively recline a backrest, said cylinder assembly being lockable during tilting of said upper frame and further comprising:
a rod of said cylinder assembly being attached to said plate;
said plate being pivotally attached to said upper frame;
a pin depending from said upper frame, said pin defining a path as said upper frame is tilted;
said pin extending into and being retained in said slot;
said slot being configured not to exert substantial resistance to said pin along said path as said upper frame is tilted in a posterior range of tilt;
said slot further being configured to cause said pin to pull said plate forward as said upper frame is tilted in the anterior direction while said cylinder assembly is locked, said plate thereby exerting a forward force on said locked cylinder assembly;
whereby posterior tilting of said upper frame does not cause said backrest to substantially recline but anterior tilting of said upper frame causes said backrest to recline.

3. A wheelchair having a tilt function comprising:
a cylinder assembly attached to selectively recline a backrest, said cylinder assembly being lockable during tilting of an upper frame of said wheelchair;
a member pivotally attached to said upper frame at a tilt pivot axis;
said cylinder assembly having a rod pivotally attached to said member at a point that is spaced from said tilt pivot axis;
a longitudinal axis of said cylinder assembly and a spacing of said point from said tilt pivot axis being selected so that said backrest does not substantially recline during posterior tilting of said upper frame but said backrest reclines during anterior tilting of said upper frame.

4. The wheelchair of claim 3 wherein a point of attachment of a cylinder of said cylinder assembly to a backrest assembly defines a path of travel during posterior tilting of the upper frame that is approximately parallel to a tilt arc of the upper frame during posterior tilting of said upper frame, said spacing being effective to cause said path of travel to deviate from said tilt arc to a greater extent than during posterior tilting so as to exert a recline force on said cylinder assembly during anterior tilting of said upper frame.

5. The wheelchair tilt mechanism of claim 4 wherein said longitudinal axis of said cylinder assembly aligns with said pivot axis at a tilt angle that is located between 10° and 20° of posterior tilt of said upper frame.
